(19) United States
(12) Patent Application Publication
(10) Pub. No.: US 2005/0244571 A1
(43) Pub. Date: Nov. 3, 2005

(54) Method and device for the production of an antireflective coating, antireflective coating, and antireflective-coated substrate

(75) Inventors: Stefan Walheim, Weingarten (DE); Jurgen Steps, Dresden-Schonfeld (DE); Martin Holzbecher, Friedrichschafen (DE)

Correspondence Address: NIXON & VANDERHYE, PC, 901 NORTH GLEBE ROAD, 11TH FLOOR, ARLINGTON, VA, 22203, US

(73) Assignee: INTERFLOAT CORPORATION, MAUREN (DE)

(21) Appl. No.: 10/514,792

(22) PCT Filed: May 21, 2003
(86) PCT No.: PCT/CH03/00327

§ 371 Date: Jun. 20, 2005

(30) Foreign Application Priority Data
May 21, 2002 (CH) 841/02
May 21, 2002 (CH) 840/02

(51) Int. Cl. B05D 5/06; B05B 15/04

(52) U.S. Cl. 427/162; 118/326

(57) ABSTRACT

In order to produce an antireflective layer, a coating solution containing at least one metal alkoxy compound and at least one polymer as solid components that are dissolved in a solvent is applied to a substrate that is to be coated by means of a pouring device with a wide slit, the polymer being immiscible and essentially inert in a chemical manner towards the metal alkoxy compound. A layer which is provided with a nanoporous structure having a refractive index that is preferably smaller than 1.22 as well as good antireflective properties is obtained by selective removal of the polymer and thermochemical hardening of the coating.

The present invention relates to a procedure and a plant for the production of a porous antireflection coating on a transparent substrates, such as glass panes made of plate glass or cast glass, an antireflection coating and an antireflection-coated substrate.

The use of hardened plate glass in solar technology makes it desirable to increase the transmission not only within narrow spectral ranges, but also integrally over the entire spectral range of solar transmission, preferably over a spectral range from about 350 to about 2000 nm. Hardened plate glass dereflected on one side is preferably needed in phovoltaics. Solar heat production, at least with the design principle employed by the greater part of producers, calls for hardened plate glass dereflected on both sides.

It is known that antireflection layers can be applied to plate glass and other light-permeable substrates by means of vacuum coating techniques. But these vacuum coating procedures are associated with considerable costs.

The coating procedures employed at present and the coating materials or chemical elements that can be used with them do not permit the coating of large areas of glass, especially plate glass, on one or both sides in a spectral bandwidth between about 350 nm and about 2000 nm. The production costs of plate glass coated with the known methods would also be too high. It would be desirable for plate glass to have a total solar transmission or light transmission that amounts to more than 75% of the theoretically possible increase.

It is known that small and high-quality substrates, eyeglasses, lenses and small plane substrates for example, can be dereflected by coating them with magnesium fluoride.

The surface properties of such layers correspond to those of plate glass or glass materials. In place of the theoretically possible increase of about 4% of the light transmission in the visible range in case of one-sided coating, only 1.3 to a maximum of two percentage points are (actually attained. It is known that, for technological and particularly cost reasons, this coating cannot be used for large-area glass coatings.

It is known that, employing vacuum coating technologies, antireflection layer consisting of multiple layer systems, for example fourfold layers consisting alternatively of ThO2 or TiO2 and SiO2 layers can be sputtered onto one side of plate glass and that with one-sided coating the physico-theoretical maximum increase of about 4% of the light transmission can almost be obtained in small spectral bands with a maximum bad width of about 200 to 250 nm. But vacuum coating technologies are very cos-intensive procedures.

It is further known that the reflectivity of plate glass surfaces can be reduced by means of a coating with esterified polymers. Given the poor rhibological properties and also the insufficient stabilities, however, the coated surfaces, prior to being subjected to, for example, mechanical loads, abrasive influences and/or environmental influences, have to be incorporated in a structure that protects them by constructive measures. Plate glass coated on one side only can be employed if necessary. With one-sided coatings it should prove possible to obtain an increase of the light transmission by 3% to close to the theoretical 4% limit within narrow spectral ranges with bandwidths of the order of 200 to 300 nm.

Several procedures for applying antireflection layers to plate glass are known to the present state of the art. A first procedure is the etching method, which—in combination with the dipping method—makes it possible to produce nanoporous structures also on large-area plate glass surfaces. The second procedure, the so-called stamping (embossing) method, is used for stamping nanoporous structures into a previously applied layer and thus to conserve the structures. Combinations with the etching procedure are possible. It is a disadvantage of both procedures that the production of antireflection layers is possible only as single layers. A sol-gel process is used in a third procedure. In this case organo-metallic compounds capable of forming condensation products are applied to the glass surfaces. In combination with dipping, even large-area glass substrates can be coated with the sol-gel procedure. The drying of the layer may be followed by a pyrolysis process by means of which the solid layer can be converted into a nanoporous antireflection layer. The aforementioned three procedures call for very costly individual technical steps that are not technologically suitable for a continuous coating of plate glass or large-area plane substrates.

A sol-gel process is described in WO 00/00854, Steiner et al. Using a dipping method, the glasses are coated with a solution of at least two polymers that are incompatible with each other. Following evaporation of the solvent and due to phase separation, on the substrate surface there comes into being a layer with essentially alternating polymer phases. The newly created layer is then exposed to another solvent with which one of the polymers, depending on the particular task definition, is either partly or wholly dissolved, so that at least a second polymer remains non-dissolved. The removal by dissolution of the one polymer creates pores in the nanometer range, i.e. pores that are of a size smaller than the wavelength of visible light or adjacent spectral regions. This procedure makes it possible to produce nanoporous antireflection layers with an index of refraction n smaller than 1.3 and down to about 1.06 and optically so effective that, given two-sided coating of small samples of 1.5 mm thick plate glass, values of the total solar transmission close to the theoretical maximum of overall more than 98...99% are obtained within a bandwidth from about 350 to about 1500 nm. Since in each case at least one polymer is a layer-forming component of the nanoporous layer, it is not possible to harden the plate glass after the coating.

But layer production in each case also calls for several individual processing steps, inclusive of washing and rinsing processes. The procedure of WO 00/00854 cannot therefore be technically and technologically adapted for continuous coating of large-area plate glass with layer thicknesses in the nanometre range.

US 6,177,131 (Glaubitt) discloses a method for the production of a porous antireflection coating in which a colloidally dispersed solution—obtained by hydrolytic condensation of one or more silicon compounds of the general formula RₐSiX₄₋ₐ and which also contains organic polymers with OH and/or NH groups and molecule masses between 200 and 500,000 in colloidally dispersed form—is applied to a substrate and dried, after which the organic components are removed by heating. The molar ratio of polymers to silane has to lie between 0.1 mmol/mol and 100 mmol/mol silane and the pH-value of the solution has to be ≧7. According to a described embodiment, the coating solution is applied to the glass by means of a dipping procedure.

WO 97/06896 discloses a method for producing a porous metal oxide film on a glass substrate. According to WO 97/06896, the first step is to mix a metal oxide and a metal acetyl acetonate, a first solvent, water, acid and an organic polymer, so that a hydrolysis and polycondensation can take place and a sol coating solution is formed. The sol coating solution is subsequently applied to the glass substrate by means of dipping. Following the evaporation of the first solvent, this leads to the formation of a gel film of organic and inorganic polymer phases. The constituted gel film is dried at a first temperature between 40 and 90° C., so that the first solvent will thereafter have been fully removed. The organic polymer phase is then removed by contacting it with a second solvent consisting of acid, water and an alcohol. The gel film is then heated to a second temperature between 550 and 690° C., so that the phase remaining in the gel film is disintegrated and a metal oxide film becomes formed. The share by weight of the metal oxide in the coating solution may fluctuate between 0.01 and 0.5 percent by weight. The stoichiometric water/metal oxide ratio amounts preferably to between 4 and 10:1. The pH-value of the solution amounts to between 1 and 3. The polymer used should preferably contain a carbonyl group, for example polyvinyl acetate, polymethyl acrylate or polyacrylic acid. The polymer will preferably account for between 5 and 30 percent by weight of the coating solution. The polymer will preferably have a molecular weight between 50,000 and 100,000. The viscosity of the coating solutions of the various embodiments fluctuated between 15 and 50 cP. Comparative tests with coating solutions having a viscosity between 5 and 18 cP produced clearly worse porous films than the embodiments with coating solutions having a viscosity greater than 15 cP.

JP-A-09 2958535 sets itself the task of producing an anti-tarnish film with long-lasting stability. To this end an oxide film with a porous structure is produced on a glass substrate by subjecting a metal oxide compound or an aqueous solution with finely dispersed oxide particles to a hydrolysis and polycondensation reaction in the presence of water, an acid and a water-soluble polymer. The coating solution is applied to the glass substrate, dried and the organic polymer removed with the help of a water/alcohol mixture. Subsequently the film is tempered at a high temperature. JP-A-09285835 provides no detailed information as to how the coating solution is applied to the glass surface.

EP-A-1 199 288 (US Ser. No. 090519/2002) discloses an aqueous coating solution for wear-resistant SiO2 antireflection layers with a pH-value between 3 and 6 containing 0.5-5.0 percent by weight of SiOx(CH)y]n particles with a particle size of from 10 nm to 60 nm and up to 0.5 percent by weight of a tenside mixture that can be obtained by means of hydrolytic polycondensation in an aqueous-alcoholic-ammonia alkali medium to which there is added a tenside mixture made of anionic, non-ionic and amphoteric tensides after the ammonia and the alcohol have been separated. EP-A-1 199 288 teaches the application of a coating solution with a solid material content of 1-3 percent by weight by means of dipping, spraying or spinning methods. In the dipping procedure the pulling speeds amount to no more than a maximum of 50 cm/min.

The coating methods described above have in common that in each case the coating solution can be applied to the substrates by means of the dipping, spraying or spin coating techniques. But these methods are not very suitable for an economic coating of large areas of glass substrates on an industrial scale.

### OBJECT OF THE INVENTION

It is the object of the present invention to suggest a procedure by means of which large glass substrate areas can quickly and efficiently be provided with a nanoporous antireflection coating one either one or both sides. Another object is to make available a nanoporous antireflection coating that, applied to a transparent substrate, leads to an enhanced total solar transmission over as large as possible a spectral range. Another object is to provide an antireflection-coated substrate having an increased transmission as compared with the uncoated substrate. Another object is to make available coated and preferably thermally treated plate glasses or plate-like substrates, especially thermally pre-stressed (so-called “hardened”) plate glasses, with increased transmission. It is a further object to coat plate glasses optionally with a smooth or regularly structured or stochastically structured surface with structure depths from about 5 nm upwards. Another object is to make available wipe-proof or mechanically stable coatings with good rhibological properties. It is a further object to make available antireflection-coated transparent substrates that visually present the same colour over the entire substrate surface. It is the object to provide nanoporous antireflection layers with an index of refraction n smaller than 1.3, preferably about 1.23 or also smaller. Another object is to make available hardened and coated plate glass that still has properties comparable with those of the glass material. Yet another object is to suggest a procedure and a coating with which the total solar transmission of plate glass can be increased by at least about 2.5% per coated boundary surface.

### DESCRIPTION

According to the invention, a procedure in accordance with the preamble of claim 1 is characterized in that the substrate to be coated is arranged on a support, that the coating solution is poured from a wide slot pourer onto the substrate and that the substrate and the wide slot pourer are simultaneously moved relative to each other in a given direction. In contrast with the hitherto know coating procedures, the method in accordance with the invention can be used for continuously coating plane substrates with metal-alkoxy compounds. The coating solution can be applied to the substrate moving relative to the distributor by means of a wide slot pourer that has roughly the same width as the substrate to be coated.

Advantageously, a solid layer will be formed by means of preferably quick, especially shock-like evaporation of the solvent immediately after application of the coating solution. This has the advantage that an even coating of the substrate with a solid layer can be produced. To the surprise of the inventor, this solid layer is so solid that the coated substrates may be handled.

Preferably, process gases that circumcirculate the coating solution issuing from the coating implement are employed at least temporarily during the procedure. This makes it possible for the condensation reactions and the hardening of the solid components into a solid layer to be purposefully delayed or accelerated. The use of process gases may particularly facilitate the hardening of the layer. Furthermore, the layer thickness can be kept substantially constant.

Preferably, the wide slot pourer, especially in the region of its exit opening or lower edge, may be surrounded or circumcirculated by a first process gas with a composition that is preferably matched to the coating solution, optionally either as a protection gas or gas with reactive components. This has the advantage that constant coating conditions are maintained and that the liquid film will not be broken. The condensation process of the metal-alkoxy compound can be purposefully controlled by means of reactive gas components. Using at least one process gas or a sequence of several process gases, the solvent can be evaporated from the coating solution very quickly or even in a shock-like manner, while other volatile reaction and decay products can be quickly absorbed and removed.

Advantageously, in at least one further step the coating solution applied to the substrate will subsequently be surrounded or circumcirculated by at least a second process gas. This may have a composition different from the first process gas and contain components that react with the coating solution. The second process gas can be used to dry the applied layer and to absorb and remove the evaporated solvent and other gaseous reaction and disintegration products. Furthermore, the hardening of the solid layer can be accelerated by the addition of components that react with the coating solution. In the case of organometal compounds, organosiloxane for example, the hardening of the layer can be accelerated by the addition of, for example, water vapour in a gaseous condition and at a concentration in the range from 20 to 90%, preferably 20 to 80%, of relative process gas moisture. The alkoxy-metal compounds of the coating solution, for example, can thus react with reactive components of the second process gas, H2O for example, and solidify. Moreover, the second process gas may optionally contain acid gases, acids and other suitable compounds in gaseous form in concentrations of less than about 10% by volume. For example, it may contain—though without being limited to these—chlorine, sulphur dioxide, HCl, CO2 H2SO4, H2SO3, HNO3, CH3COOH, water-soluble chlorides, hydrogen sulphates and sulphites.

Preferably, in the region of the application of the process gases additionally optional will be made of IR and UV radiation sources to trigger radiation induced reactions in the coating. This can be done in combination with the second process gas. The desired composition of the employed gas atmosphere can be produced by means of mixing with the help of a mixing plant and then conveyed through appropriate pipelines to the desired place. The desired individual concentrations of reactive vapours and gases can be produced in accordance with the technical reaction conditions by admixture, preferably in an overall concentration of less than 20% by volume.

The use of controlled atmospheres in the area of the place of application of the coating solution, makes it possible to exert a favourable influence on the quality of the coating and the reproducibility of the process. Given a quick, shock-like evaporation of the solvent immediately after the coating and the preferably simultaneous effect of the reactive components of the process gases on the applied liquid layer, it is possible for solid coatings with layer thickness from about 20 nm onwards, preferably between 100 and 400 nm, to be applied homogeneously. In particular, the method has the advantage that the solidified layer applied to the substrate is mechanically so stable as to permit several substrates to be edgewise stacked together already immediately after the coating and/or without further intermediate treatment the layer being thermochemically transformed or hardened by means of a high-temperature shock treatment, in the case of plate glass during the glass hardening and deformation processes. Due to the high-temperature thermoshock treatment, the polymer is removed by means of a pyrolytic process and the solid layer is converted into a nanoporous layer, especially an antireflection layer. As in every pyrolytic process, the essential thing is not solely the temperature, but rather the so-called temperature-time product. Well suited are temperatures from about 600° C. onwards. The nanoporous layers produced in this manner may have a refraction index n<1.3, preferably n<1.23 and even more preferably n<1.22. The coating procedure makes it possible to optionally produce a coating with a refraction index gradient normal to the surface, the refraction index of plate glass passing to that of air or some other adjacent medium. The procedure can therefore be put to very many-sided uses and is also very economic.

Contrary to previous teachings, it was surprisingly found that coating solutions with a small solid material content and a low viscosity can be applied in accordance with the expansion coating procedure combined with the free-fall coating procedure with a wide slot extrusion pourer (hereinafter referred to also as wide slot pourer”).

Advantageously the coating solution will have a low viscosity, i.e. a viscosity of less than 20 mPas (millipascal seconds), preferably less than 10 mPas and even more preferably <5 mPas. Advantageously, the internal normal stress (at right angles to the shear stress) will be greater than 2 Pascal.

Advantageously, the polymer to be used will be a polymer that is substantially chemically inert with respect to the employed metal-alkoxy compound. The use of polymers that are not capable of chemically reacting with the employed metal-alkoxy compounds seeks to assure that a cross-linking reaction with any one of the intermediate hydrolysis or intermediate condensation stages of the employed alkoxy compound can be excluded. The coating procedure is characterized by reaction conditions that force a polymerization of the alkoxy compounds with each other into a chain-like solid gel.

Advantageously, use is made of an essentially non-polar polymer, without OH or NH groups. Advantageously, the polymer will be essentially non-polar and preferably belong to one of the following groups: polyacrylates, polycarbonates, polyethylene oxides, polymethyl acrylates, polymethyl metacrylates, polystyrenes, polyvinyl chlorides, polyvinyl pyridins (P2VP and P4VP), Teflon AF.

Advantageously, the pH of the coating solution will have a value <7. Due to the use of an alkoxy compound with a pH-value smaller than 7, the solid layers formed (during a rapid evaporation of the solvent) will be chainlike-linked aggregates in the gel state. Alternating with them, either by their side or between them, there will be the previously described polymer regions of different sizes according to the polymerization conditions in acid environment. In contrast therewith, the particles formed in an alkaline environment would be colloidal and would in any case condense right away into nanoporous gel layers with nanopores that are comparably smaller than the size distribution of the polymers. Preferably, the coating solution will have a pH-value between 2 and 6. It has been found experimentally that with these pH-values and suitable concentrations of the reactive components of the process gases it is possible to obtain similar nanoporous microstructures of good uniformity.

Advantageously, a certain quantitative share of one or more acids will be dissolved in the solvent. For example, the following acids may be used, though one is not limited to them: HCl, H₂SO₄, H₂SO₃, HNO₃, CH₃COOH. The acids serve to set a particular desired pH-value. For a uniform coating it will be advantageous to set the pH-value of the coating solution with an accuracy of ±0.1.

The weight proportion of the water in the solvent is preferably chosen in accordance with the solid material concentration of the share of the two solids in the coating solution. A small water component can accelerate the solidification of the metal-alkoxy compound.

Preferably, use will be made of a slightly volatile and preferably organic solvent. Examples of solvents are: acetone, acetic acid methyl ester, cyclohexane, benzene, butyric acid, methyl propionic acid, octane, tetrahydrofurane, toluene. Advantageously, water will be dissolved in the solvent. The share by weight of the solids will preferably be less than 15% preferably less than 10%. Advantageously, the ratio of the solid components of metal-alkoxy compound and polymer in the coating solution (=solution) will be in the range between 1:5 and 5:1.

Advantageously, use is made of metal-alkoxy compounds of the elements Al, Ce, Ga, In, Nd, Si, Sn, Ti, Th, Tl and/or Zr. Stable and well adhering transparent layers can be produced with organic compounds of these elements. Preferably, use is made monomeric metal-alkoxy compounds. Particular preference is given to monomeric metal-alkoxy compounds with “w”-fold linkage, for example silanes with four-fold linkage.

Preferably, use is made of metal-alkoxy compounds of the general composition R_{α}MeX_{w-α}, where w, X, T, α and Me have the following meanings:

w: Valency of the metal Me

X: only moieties by which the aforesaid general composition can be hydrolized and condensed; for example H: hydrogen, halogen, hydroxy and alkoxy groups, acyloxy, alkycarbonyl, alkoxycarbonyl or substituted or unsubstituted amines.

R: organic moieties with between 1 and about 10 carbon atoms;

α: Index of the numbers 0,1,2

Me: Glass-forming elements or especially Al, Ce, Ga, In, Nd, Si, Sn, Ti, Th, Tl and/or Zr. Given the use of the previously described metal-alkoxy compounds, it is possible to obtain antireflection layers for which in the region between 400 and 2000 nm the total solar transmission of the transparent substrate, for example with one-sided coating of a plate glass, can be increased by at least 2.5%. In contrast with the nanoporous antireflection layers of U.S. Pat. No. 6,177,131, the total solar transmission is increased over a substantially larger spectral range.

A silane of the general formula SiX₄ is used as metal-alkoxy compound and Si(OCH₃)₄ (TMOS) is given special preference. Silane compounds, for example tetra alkoxy silanes, yield particularly stable coatings by virtue of the fact that they adhere particularly well to the glass surface.

Advantageously, the substrate will be passed under the underside of the wide slot pourer at a speed that in each case is constant in the range between 2.0 and 30.0 m/min, preferably in the range between 4.0 and 18.0 m/min, and covered with a layer of the coating fluid. Advantageously, use is made of coating solutions that are essentially true and homogeneous. These solutions can be readily applied with a wide slot pourer at the given speed. The solid material thicknesses produced with the given coating procedure are preferably smaller than 1 μm. As compared with the dipping process, the described procedure permits the carrying out of a continuous and economic production process of high productivity.

Preferably, the distance between the lower edge of the pourer and the substrate surface will be set be means of a level adjustment device of the wide slot pourer. A further device can be used to modify the extrusion angle of the wide slot pourer relative to the substrate normal. This can be quickly realized as part of the procedure and it is thus possible to coat different substrate thicknesses.

Using the procedure in accordance with the invention, plate-like substrates can be coated, on either one or two sides, with both single layers and also with two or more layers on top of each other, these solid material layers having either identical or also different thickness. Preferably, the substrates for multi-layer coatings are coated within the ambit of an automated production line, optionally by a sequence of two or more wide slot pourers either in sequence or fed back either once or repeatedly to one wide slot pourer via a technically and logistically suitable by-pass. Either plate glass, smooth or polished plate-shaped metals, plates made of mineral substances or other transparent or non-transparent materials can be used as substrates. Examples of plate glass are float glass, cast glass with arbitrarily regular and/or stochastically structured surfaces, including finely hammered surfaces, antique glass, which—due to the conditions in which it was produced—is uneven, other plate-like transparent materials that are temperature-resistant from about 250° C. onwards, polished plates made of metals and other inorganic materials. The application of antireflection coatings to transparent substrates can purposefully increase the total solar transmission. The surfaces of non-transparent substrates can be purposefully and creatively modified by the application of antireflection layers, for example by partial dereflections or by colour interference creation in reflection.

According to a particularly preferred variant, the utilized polymer is removed from the solid layer applied to plate-shaped substrates. This can be done, for example, by leaching it out with a suitable solvent that could be, among others, alcoholic, etheric or aromatic. Alternatively, the polymer can be removed by means of a pyrolytic process that does not harm the substrate. Nanoporous layers with antireflection properties can be obtained by means of this procedure. The total solar transmission can be stepped up by at least about 2%.

An acid environment has the advantage of the formation of chain-like aggregates in the gel state that link with each other into solid layers. Alternating either by their side or between them, there are the previously described polymer areas of different sizes according to the polymerization conditions. It has been found experimentally that, given pH-values between 2 and 6 and appropriate concentrations of the reactive components of the process gases, it is possible to obtain nanoporous structures of good uniformity. Other advantageous further developments of the procedure are defined in the already discussed dependent claims.

Object of the present invention is a device in accordance with claim 37, which is characterized in that the coating implement is a wide slot extrusion pourer with a slit-shaped outlet opening and that there is provided a device for circumcirculating the wide slot extrusion pourer with a process gas atmosphere at least in the region of the exit opening. This device could be a hood, or also a chamber that is substantially closed against the surrounding atmosphere, under which the wide slot extrusion pourer is arranged. The coating can thus be carried out in a defined process atmosphere. Advantageously, there will be provided at least one gas preparation plant that communicates with the chamber and makes available and/or mixes inert and/or reactive gas components. This makes it possible to utilize different gas atmospheres. The chamber may be provided with at least two connections for feeding and removing a process gas or process gas mixture. The chamber, in which the wide slot extrusion pourer is arranged, may be subdivided into at least two reaction spaces. Gas guidance devices may also be provided, for example guide sheets or lines with guide sheets, so that the gases can be purposefully directed towards the substrate surface or sucked away therefrom. Further advantageous embodiments of the coating plant are defined in the dependent claims.

Another subject of the present invention is an antireflection coating obtainable by means of the procedure in accordance with the invention. In contrast with known antireflection layers, the antireflection layer in accordance with the invention is distinguished by an enhanced transmission over a large spectral range.

Hereinafter the invention will be described by way of example and in greater detail by reference to the figures, of which:

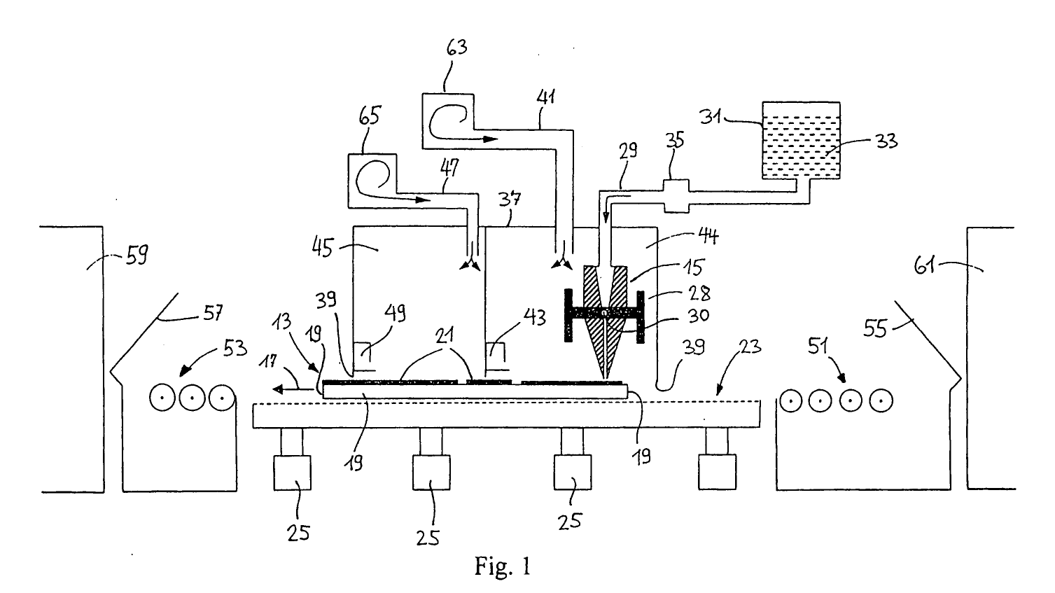

FIG. 1 shows a device for coating glass substrates;

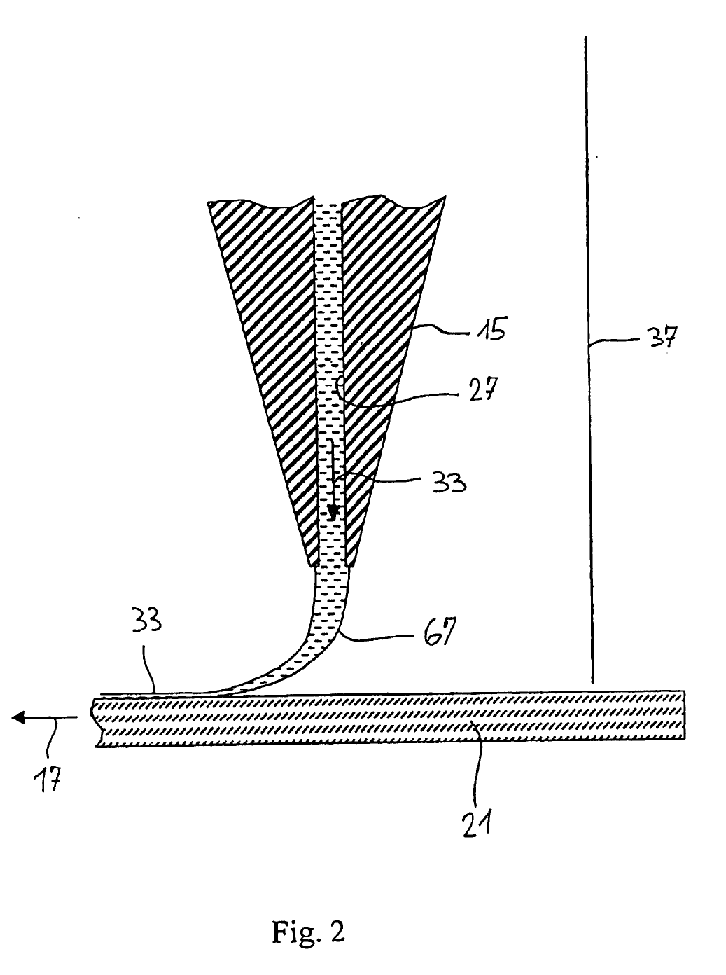

FIG. 2 shows a wide slot pourer in greater detail; and

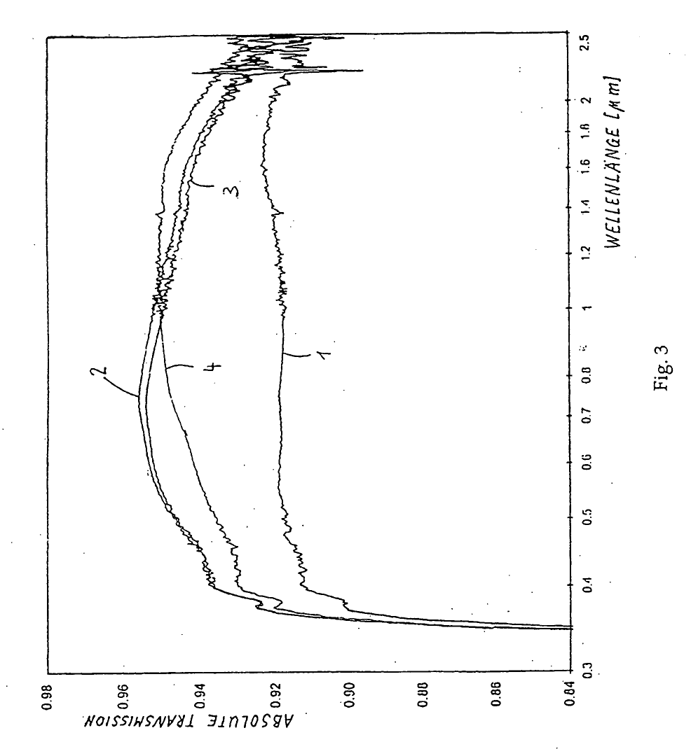

FIG. 3 shows a comparison of the transmission spectra between 300 and 2500 nm of various glasses that were coated by means of the procedure in accordance with the invention.

The coating device 11 shown in FIG. 1 comprises a transport installation 13 and a wide slot pourer 15 arranged above the transport installation 15. The transport installation 13 comprises a support 19 capable of moving in the transport direction 17 on which platelike substrates 21, especially plate glass, can be arranged for the purpose of being coated. The support 19 rests on an substructure 23 that is not shown in detail and can be moved relative to it. The support 19 can also have its height varied by means of height adjustment device 25, so that substrates 21 of different thicknesses can be coated.

In accordance with the preferred embodiment, the wide slot pourer 15 is a wide slot extrusion pourer with a slot 27 that extends at right angles to the transport direction 17. The slot has a width between 0.02 and 1.0 mm, preferably between 0.08 and 0.3 mm. The wide slot extrusion pourer 15 is arranged in a frame 28 and is capable of being pivoted about a horizontal swivel axis 30 running at right angles to the transport direction. Furthermore, the wide slot extrusion pourer is connected to a storage container 31 by means of a supply line 29. The storage container 31 serves to accommodate a coating solution 33. A dosing pump 35 makes possible an accurate dosing of the quantity of liquid fed to the wide slot extrusion pourer. Basically it is conceivable to control the dosing of the liquid quantity via the hydrostatic pressure.

The wide slot extrusion pourer 15 is arranged under a hood or in a chamber 37. The chamber 37 covers the transport installation 13 in width and is closed with the sole exception of a slot 39 provided between the support 19 and the transport installation 13. Preferably, the chamber 37 is subdivided into at least a coating chamber 44, in which the wide slot extrusion pourer 15 is arranged, and a drying chamber 45 adjacent to the reaction chamber 44 in the transport direction. A first working or process gas, especially a reactive gas, can be fed into the coating chamber 14 via a line 41. A first gas preparation device 63, to which there is connected the line 41, serves to mix various gases. Excess gas can be led or sucked away by means of an exit opening 43 provided in the coating chamber 44.

The wide slot extrusion pourer 15 is arranged under a hood or in a chamber 37. The chamber 37 covers the transport installation 13 in width and is closed with the sole exception of a slot 39 provided between the support 19 and the transport installation 13. Preferably, the chamber 37 is subdivided into at least a coating chamber 44, in which the wide slot pourer 15 is arranged, and a drying chamber 45 adjacent to the reaction chamber 44 in the transport direction. A first working or process gas, especially reactive gas, can be fed into the coating chamber 14 via a line 41. A first gas preparation device 63, to which the line 41 is connected. Serves to mix various gases. Excess gas is led or sucked away by means of an exit opening 43 provided in the coating chamber 44.

Just like the coating chamber 44, the drying chamber 45 covers the width of the transport installation 13, so that substrates 21 arranged on the support 19 can be contacted by a given second process gas atmosphere that is different from the first. A feed line 47 serves to feed a second process gas or gas mixture, especially a drying gas, into the drying chamber 45. A second gas preparation device 65, to which the feed line 47 is connected, serves to mix various gases. The gas can then be sucked away via an exit opening 49 provided in the chamber 45.

A support-loading station 51 and a support-discharging station 53 are provided, respectively, upstream and downstream of the coating device 11. These stations 51,53 serve, respectively to load uncoated substrates onto the support 19 and to discharge coated substrates from it. The swivelling stackers 53,57 permit the loading of uncoated substrates and the discharge of the coated substrates.

A hardening furnace 59 may be provided downstream of the swivelling stacker 57. The hardening furnace may be used, for example, for thermally pre-tensioning glass that has previously been coated in the coating device 11. The pre-tensioning of the glass and the final treatment of the applied layer (for example, pyrolytic removal of organic components) may be effected at the same time. A known surface cleaning plant 61 not here shown in detail may be arranged on the upstream side of the coating device 11.

FIG. 2 shows the lower part of a wide slot pourer 15 in greater detail. The wide slot pourer has a wide slot opening 27 with a given slot width and slot height. The slot height makes it possible to obtain an evening out of the pressure conditions in the wide slot pourer and therefore also of the quantity transported in unit time. Due to the chosen transport speed of the substrate 21, the liquid curtain 67 is expanded in the transport direction 17.

The coating procedure in accordance with the invention will no be described by using the production of an anti-reflection coating as example.

The plate glass surfaces have first to be cleaned and made available free of chemical impurities and dust-like deposits. A monomeric alkoxy compound of silicon, or of another metal, preferably one producing fourfold reticulation, (for example Al, Ce, Ga, In, Nd, Sn, Ti, Th, Tl and/or Zr), is dissolved in an organic solvent that has a high vapour pressure at room temperature. The coating solution further contains at least one polymer with a molecular weight smaller than 10,000,000, but preferably greater than 500,000, that preferably does not contain any OH and/or NH groups. The use of oligomers as primer stages for preliminary stages that react in situ with polymers is however likewise conceivable. Chemically the employed polymer compound should however be substantially inert with respect to the monomeric alkoxy compound. Furthermore, the polymer compound and the alkoxy compound should not be capable of being mixed together. As examples of polymers or oligomers that within the framework of the procedure in accordance with the invention comply with the aforesaid limitations, mention may here be made of polyacrylate, polycarbonate, polyethylene oxide, polymethyl acrylate, polymethyl metacrylate, polystyrene, polyvinyl chloride, polyvinyl pyridine (P2VP and P4VP) or Teflon AF. Coating solutions made with one or more of the aforesaid polymers and one or more alkoxy-metal compounds are characterized in that, subject to the chemical effect of the process gases, the rapid and shock-like evaporation of the solvent desired in the process solidifies the applied liquid layer into a solid layer. This solid layer consists of a statistically distributed, alternating three-dimensional areas of the two solid material components, areas of the cross-linked polymer—of which the size and size distribution following pyrolysis determines the porosity distribution in the nanoporous reflection layer—and areas of a solid gel of the employed alkoxy compound cross-linked (reticulated) in the manner of a chain.

The coating solution is preferably set to a pH-value of less than 7. To this end some water and an acid (hydrochloric or sulphuric acid, for example) may be added to the organic solvent. The quantity of water is added in a sub-stoichiometric ratio with the quantity of monomeric alkoxy compound producing fourfold cross-linking, so that an uneven size distribution of the primary particles in the sol will purposely be obtained. As far as this intermediate chemical process is concerned, the accurate setting of an appropriate ph-value in the region between 1 and 6, preferably between 2 and 6, calls for the addition of a small quantity of acid.

If the applied solid layer is to attain a thickness within the range of about 100 to 400 nm prior to the high-temperature hardening process, the solid content in the solution should be less than 15% by weight. Within the limits of this overall solid content, the quantity ratio between the two macromolecular components may lie within the range from 1:5 to 5:1. The ratio of the two components depends essentially on the kind and the molecular weight of the employed substances.

Particularly suitable are coating solutions with an internal liquid cohesion—measured at right angles to the shear stress—that is characterized by a normal tension greater than about 2 Pa (Pascal).

The coating of large-area plate-like substrates, which comprise also plate glass panels, may be carried out continuously by means of a liquid film falling freely in either a vertical or an inclined direction: after the coating solution has struck the leading edge (the forward edge as seen in the transport direction), it immediately expands as a liquid curtain over the entire width of the substrate and perpendicularly to the transport speed¹. This also assures a uniform coating and layer thickness even in the edge areas. Preferably, the employed coating solution will have a low viscosity, especially less than 20 mPas.

According to the present invention, coating solutions produced and made available with a wide-slotted extrusion pourer of this kind are applied by means of a combined expansion layer and free fall procedure to plate glass or also other plate-shaped substrates—which are still collectively referred to as substrates—that are led past beneath them. During coating operations a free-hanging liquid film bridges the distance between the lower edge of the wide slot pourer and the substrate surface. Due to an appropriate transport speed of the substrate, moreover, the liquid film on the substrate surface is also expanded in the transport direction.

The wide slot pourer has preferably a slot of a width between 0.02 and 0.8 mm, preferably between 0.05 and 1.0 mm, and even more preferably between 0.05 and 0.35 mm. The distance between the substrate surface and the lower edge of the wide slot pourer may vary in the range between 0.1 and 1.0 mm, preferably between 0.2 and 0.8 mm. The length of the wide slot may preferably amount to more than 1 m without discontinuity. The aforesaid parameters are chosen in accordance with the properties of the coating solution and the technical production requirements or matched with them.

A preferably vibration-free support should be used in order to assure an adequate accuracy of the thickness of the applied solid layer. The support may be provided with vacuum suction or other means for fixing substrates of different sizes. Advantageously, the height of the transport plane with respect to the lower edge of the pourer will be set with great accuracy, preferably within ±0.02 mm. The transport speed should be capable of being set with an error of less than 1%.

A protective gas sheath containing, for example, nitrogen or alternately reactive gases, may be provided, preferably in the immediate vicinity of the lower edge of the wide slot pourer. This helps to assure that, notwithstanding the quasi-continuous working mode, the wide slot extrusion pourer is continuously ready for being operated and that the substrates fed one after the other will be uniformly coated from their leading edge onwards.

After the applied layer has been rendered effectively uniform, the coated section of the substrate surface reaches an adjacent drying chamber, where a second process gas, preferably designed as a drying gas, can take up the evaporated solvent and other gaseous reaction products. Due to the particular composition of the individual gas components of the second process gas and, if so desired, in combination with an IR or UV radiation bed, the quality of the solidification and the drying speed and the applied layer can be controlled. These processes lead to the formation of a layer of solid material on the substrate of which the thickness—depending on the thickness of the applied liquid layer and the solid material content brought into solution—should amount to at least about 20 nm, but will preferably lie in the range between 100 and 400 nm.

The solid layer produced in this manner consists of alternating dense areas of the two material components, the cross-linked polymer and the chainlike linked gel of the original alkoxy metal compound, preferably an alkoxy-silane compound. These material areas exist incompatibly next to each other as three-dimensional areas with statistically distributed different sizes in the nanometre range.

In the next step of the procedure, by a high-temperature shock treatment in a glass hardening process, the polymer is removed from the three-dimensional solid matrix produced in this manner almost without a residue by means of a pyrolytic process. A porous and highly cross-linked anti-reflection layer is thus brought into being from the original alkoxy compound. The anti-reflection layer produced in this manner will then have the property of increasing the total solar transmission of the plate glass coated in this manner by at least 2.5%.

Should the produced solid layer be applied to other plate-like transparent materials that exhibit temperature stability above about 250°, the polymer appropriately chosen for this purpose can be removed without leaving a residue by means of a pyrolysis process that will conserve the substrate. The total transmission of the substrate coated in this manner can thus be increased by at least 2%. Given substrates having a lesser temperature stability, process gases containing gaseous solvent can be made available within the framework of this procedure. Specially chosen and employed polymers and oligomers can be selectively dissolved out of the three-dimensional matrix of the applied solid layer.

According to the present invention, the procedure can also be used to coat plate-like metallic and other non-transparent mineral substrates and the solid layers applied in this manner can then once again be transformed into anti-reflection layers by means of a high-temperature shock treatment, so that in this way substrates with, for example, dereflections and/or with surfaces that cause specially designed colour interference effects can be made available.

### Embodiment Examples

### 1^{st} Example

Production of a glass plate coated on one side with an anti-reflection layer to increase the total solar transmission.

In a suitable sequence and mixture, a silane producing fourfold cross-linking, a polymethyl acrylate with a molecular weight of 996,000, sulphuric acid and water are dissolved in a solvent that is effective for all substances and has a high vapour pressure at room temperature, setting an appropriate ratio between the two macromolecular materials and forcibly mixing the solution. The solid component of the coating solution amounts to a total of 5%.

The following values of the rheological properties were measured:

Viscosity=0.60 mPas,

Normal tension=8.5 Pa

The coating speed amounts to 7.0 m/min. The thickness of the solid material amounts to about 330 nm. By means of a high-temperature shock treatment in the glass hardening process, an average increase of the total solar transmission—as compared with uncoated plate glass—of 2.8% (measured with the Ulbricht sphere) is obtained in the spectral range from 450 to 1500 nm.

### 2^{nd} Example

Production as in Example 1 but with a solids content reduced by 50%. As compared with Example 1, the solids content of the coating solution amounts to only 2.3%. The share of polymethyl acrylate was reduced to a third as compared with Example 1. The addition of sulphuric acid and water was diminished in proportion to the reduction of the silane:

The following values of the rheological properties of the coating solution were measured:

Viscosity=0.43 mPas,

Normal tension=2.8 Pa

The coating speed amounts to 7.0 m/min. The thickness of the solid material amounts to 240 nm.

By means of the high-temperature shock treatment in the glass hardening process, an average increase of the total solar transmission—as compared with uncoated plate glass—of 1.8% (measured with the Ulbricht sphere) is obtained in the spectral range from 450 to 1500 nm. The anti-reflection layer was strikingly uneven to the naked eye.

As compared with Example 1, Example 2 shows that the share by weight of the solid substances and the weight shares of the various components with respect to each other exert a substantial influence on the quality of the anti-reflection layer.

### 3^{rd} Example

Production of glass plates with single- or multiple layer coatings on one and/or both sides.

When producing multiple coatings on glass plates, the simply coated glass plates or other substrates are either fed back by means of a technological by-pass or coated with the help of a second wide slot pourer. After leaving the coating chamber, the applied solids layer is mechanically so stable as to permit substrates coated on one side to be moved even on the coated side by means of the automated transport customary in the glass processing industry. As far as processing possibilities are concerned, prior to the glass hardening process one may therefore choose either to coat the rear side of the substrate with the same coating solution and the same coating conditions, or to coat the substrates once again on either one or two sides to obtain a double coating.

Changing the substrate speed and/or the flow quantities, it becomes possible to modify the layer thicknesses and to produce multiple layers with different applied layer thicknesses and layer structures. The solids layers on the plate glass are transformed into nanoporous anti-reflection layers by means of the subsequent high-temperature heat shock. A glass plate coated in this manner attains an index of refraction n up to about 1.1 with respect to the adjacent air and, given one-sided coating, FIG. 4 illustrates the transmission in the spectral range between 300 nm and 2500 nm of various glasses. Curve 1 corresponds to an uncoated reference glass (cast glass plate). In the range between about 400 nm and 2000 nm the transmission now amounts to just over 92%. The curves designated with 2 and 3 illustrate the transmission following coating of the plate glass with an anti-reflection layer in accordance with the invention. The measured curves were obtained by measuring the transmission at points on the same plate lying far apart. The total transmission is more or less the same for both curves. Curve 4 shows the transmission of a coated plate of cast glass with an anti-reflection layer that is 20% thicker than the corresponding layers associated with curves 2 and 3. It can clearly be seen that the maximum of Curve 4 is displaced towards greater wavelengths.

Modifying the pore structure—pore size and pore size distribution—and setting the layer thickness, it even becomes possible to increase the total solar transmission by more than 3% for predetermined spectral ranges, while yet maintaining the total transmission.

Legend

11 coating plant
13 transport installation
15 wide slot extrusion pourer
17 transport direction
19 support
21 plate-shaped substrates, especially plate glass
23 substructure
25 height adjustment device
27 wide slot gap
28 frame
29 feed line
30 swivel axis of the wide slot pourer
31 storage container
33 coating solution
35 dosing and pressure maintenance device, pressure pump for example
37 chamber
39 slot between transport device and chamber 37
41 pipeline
43 exit opening
44 coating chamber
45 drying chamber
47 feed line
49 exit opening
51 loading device
53 unloading device
55,57 swivelling lever
59 hardening furnace
61 surface cleansing plant
63 first gas preparation device
65 second gas preparation device
67 liquid curtain

1. A procedure for producing a porous antireflection coating on plane transparent substrates like glass plates made of float glass or cast glass, or also non-transparent substrates, by
applying a coating solution containing as solid material components dissolved in a solvent at least one metal-alkoxy compound and at least one polymer;
removing the solvent; and
removing the polymer, characterized in that
the substrate to be coated is arranged on a support,
the solvent solution is applied to the substrate from a wide slot pourer and at the same time the support and the wide slot pourer are moved relative to each other in a given transport direction.

2. A procedure in accordance with claim 1, characterized in that a layer of solid matter is formed on the substrate immediately after the application of the coating solution by means of preferably rapid, especially shock-like evaporation of the solvent.

3. A procedure in accordance with claim 1, characterized in that process gases are used during the procedure for at least part of the time.

4. A procedure in accordance with claim 3, characterized in that the wide slot extrusion pourer, especially the region of its lover edge, is surrounded or circumcirculated by a first process gas that preferably contains reactive gas components.

5. A procedure in accordance with claim 3, characterized in that the coating solution applied to the substrate is subsequently surrounded or circumcirculated by a second process gas in at least one subsequent step.

6. A procedure in accordance with claim 3 , characterized in that each of the process gases consists of one or more reaction-poor or inert carrier gases, preferably nitrogen, and optionally admixed vapours and gases that are reactive in particular as regards the coating solution.

7. A procedure in accordance with claim 3, characterized in that in both process gases there are contained, with a total content share of less than about 10% by volume, optionally acidic gases and or acids in the gaseous state and/or other suitable compounds, for example chlorine sulphur dioxide, HCl, CO₂, H₂SO₂, H₂SO₄, HNO₃, CH₃COOH, water-soluble chlorides, hydrogen sulphates and sulphites or mixtures of two or more of the aforementioned substances.

8. A procedure in accordance with claim 1, characterized in that by means of a process gas or a succession of several process gases the solvent is evaporated from the coating solution very quickly or in a shock-like manner and other volatile reaction and disintegration products are taken up and removed.

9. A procedure in accordance with claim 1, characterized in that the polymer is essentially non-polar and preferably forms part of one of the following groups: polyacrylates, polycarbonates, polyethylene oxides, polymethyl acrylates, polymethyl metacrylates, polystyrenes, polyvinyl chlorides, polyvinyl pyridines (P2VP and P4VP), Teflon AF, etc.

10. A procedure in accordance with claim 1, characterized in that the pH of the coating solution has a value of less than 7, preferably a pH-value of less than 3.

11. A procedure in accordance with claim 1, characterized in that water is dissolved in the employed solvent.

12. A procedure in accordance with claim 1, characterized in that the solid material components are dissolved in a slightly volatile, preferably organic solvent.

13. A procedure in accordance with claim 1, characterized in that the share by weight of metal-alkoxy compound and polymer amounts to less than 15% of the solid material components, preferably less than 10%, and even more preferably less than 5%. 14. A procedure in accordance with any one of claims 1 to 13, characterized in that the ratio by weight of the solid material components of metal-alkoxy compound and polymer lies in the region between 1:5 and 5.1.

14. A procedure in accordance with any one of Claims claim 1, characterized in that the ratio by weight of the solid material components of metal-alkoxy compound and polymer lies in the region between 1:5 and 5.1.

15. A procedure in accordance with claim 1, characterized in that metal-alkoxy compounds are employed, in particular of the elements Al, Ce, Ga, In, Nd, Si, Sn, Ti, Th, TI, Zr, Ce and/or other rare earth metals, preferably of the element Si.

16. A procedure in accordance with claim 1, characterized in that use is made of monomeric metal-alkoxy compounds of the general composition R_{α}MeXw._{α}, where w, X, T, α and Me have the following meanings:
w: valency of the metal Me;
X: only moiety over which the aforesaid general composition can be hydrolized and condensed; for example hydrogen, halogen, hydroxy and alkoxy groups;
R: organic moiety with between 1 and about 10 carbon atoms;
α: index of the numbers 0, 1, 2
Me: for example Al, Ce, Ga, In, Nd, Si, Sn, Ti, Th, TI, Zr, and/or rare earths.

17. A procedure in accordance with claim 1, characterized in that a silane of the general formula SiX₄, and especially preferred Si(OCH₃)₄ (=TMOS), is used as metal-alkoxy compound, where X is a moiety over which the metal-alkoxy compound can be hydrolized and condensed, for example a halogen, a halogenized group, a hydroxy group or an appropriate organic moiety between 100 and 400.

18. A procedure in accordance with claim 1, characterized in that the coating solution is of low viscosity and preferably has a viscosity of less than 20 mpas, and even more preferably less than 10 mpas.

19. A procedure in accordance with claim 2, characterized in that the solidified layer has a layer thickness from about 20 nm onwards, preferably between 100 and 400 nm.

20. A procedure in accordance with claim 2, characterized in that the solid material layer applied to the substrate is hardened without any further intermediate treatment by means of a high-temperature shock treatment, in the case of plate glass preferably during the technically customary glass hardening and/or deformation process jointly with the plate glass.

21. A procedure in accordance with claim 2, characterized in that the polymer is removed by means of the high-temperature shock treatment in a preferably pyrolytic process and the solid material layer is transformed into a nanoporous layer, in particular into an antireflection layer.

22. A procedure in accordance with claim 2, characterized in that the nanoporous layer is an antireflection layer with a refraction index n<1.3, preferably <1.23, and even more preferably <1.22.

23. A procedure in accordance with claim 1 , characterized in that by means of the coating procedure there is optionally produced a coating with a refraction index gradient normal to the substrate surface, the refraction index of the plate glass passing into a smaller refraction index and preferably into the refraction index of the air or of another adjacent medium.

24. A procedure in accordance with claim 1, characterized in that the internal normal stress of the coating solution is set to a value greater than 2 Pa.

25. A procedure in accordance with claim 1, characterized in that the substrate is passed under the wide slot extrusion pourer at a speed that in each case is constant in the range between 2.0 and 30.0 m/min, preferably in the range between 4.0 and 18.0 m/min, and is covered with a liquid layer of the coating solution.

26. A procedure in accordance with claim 1, characterized in that the substrate is coated by means of a continuous process.

27. A procedure in accordance with claim 1, characterized in that the liquid layer is irradiated with a UV radiation source at least in the region of the second process gas.

28. A procedure in accordance with claim 1, characterized in that the desired composition of the process gases is obtained by mixing and is conducted to the desired location.

29. A procedure in accordance with claim 1, characterized in that the process gases, following contact with the liquid layer, are conducted away and their composition is measured for control purposes.

30. A procedure in accordance with claim 1 , characterized in that further layers are applied after the application of the first layer.

31. A procedure in accordance with claim 1, characterized in that to one or both sides of plate-like substrates there are applied both single layers or two or more layers on top of each other with either identical or different solid material thickness.

32. A procedure in accordance with claim 1, characterized in that the substrates for multiple coating are fed back by means of a technically and logistically adapted by-pass forming part of an automated production line or are kept circulating in a closed cycle.

33. A procedure in accordance with claim 1, characterized in that plate glass, smooth or polished plate-shaped metals, mineral substances or other transparent plates are used as substrates.

34. A procedure in accordance with claim 1, characterized in that a plate glass is used as substrate, for example a float glass or a cast glass, with arbitrarily regular and/or stochastically structured surfaces, for example with finely hammered surfaces.

35. An antireflection coating obtainable by means of a procedure in accordance with claim 1, in particular a coating with a refraction index n<1.22.

36. An antireflection coating in accordance with claim 35, characterized in that plate glass in the form of antique glass, which due to its production conditions is irregularly uneven, is coated with nanoporous antireflection layers.

37. A plate-like substrate with an antireflection coating obtainable by means of a procedure in accordance with claim 1.

38. A device (11) for continuously coating large areas of transparent plate-like substrates, especially of such substrates as plate glass, with thin layers for optical improvement and also other transparent surface improvements, with
a support on which a substrate to be coated can be arranged,
a coating implement (15) with an exit opening that is arranged above the support,
a reservoir to accommodate a coating solution,
a connecting line between the reservoir and the coating implement,
a transport installation (13) for assuring a relative motion between the support and the coating implement in a given transport direction, characterized in that the coating implement is a wide slot extrusion pourer (15) with a slit-shaped exit opening, and that there is provided a device for circumcirculating a process gas atmosphere around at least the region of the exit opening of the of the wide slot extrusion pourer.

39. A device in accordance with claim 38, characterized in that there is provided a hood or a chamber (37) that is substantially closed with respect to the surrounding atmosphere and that the wide slot extrusion pourer is arranged under it.

40. A device in accordance with claim 38, characterized in that there is provided a dosing and/or pressure maintenance device (35) that is in communication with the wide slot extrusion pourer(15).

41. A device in accordance with claim 38, characterized in that there is provided at least one gas preparation device (63) for mixing and or making available inert and/or reactive gases, said gas preparation device communicating with the chamber (37) via a pipeline.

42. A device in accordance with claim 38, characterized in that the chamber is provided with at least two connections for supplying and removing a process gas or process gas mixture, at least one of which communicates with the gas preparation device (63).

43. A device in accordance with claim 38, characterized in that the chamber (37) is subdivided into at least two reaction spaces, a coating chamber (44) and a drying chamber (45).

44. A device in accordance with claim 38, characterized in that the width of the wide slot opening (27) can be set in accordance with the properties of the coating solution.

45. A device in accordance with claim 38, characterized in that the transport installation (13) has a preferably mobile support (19) to which the substrates (21) can be fixed.

46. A device in accordance with claim 38, characterized in that the slot width of the wide slot extrusion pourer (15) can be set to a value smaller than 1.2 mm, preferably between about 0.02 and 0.8 mm and even more preferably between 0.08 and 0.3 mm.

47. A device in accordance with claim 38, characterized in that the distance between the transport installation (13) and the support (19), respectively, and the lower edge of the wide slot extrusion pourer (15) can be varied or set.

48. A device in accordance with claim 38, characterized in that the wide slot extrusion pourer (15) is arranged in a plane that is substantially perpendicular to both the transport direction (17) of the substrate (21) and the support surface.

49. A device in accordance with claim 38, characterized in that the wide slot extrusion pourer (15) is arranged above the transport installation (13) or the support (19).

50. A device in accordance with claim 38, characterized in that the wide slot extrusion pourer (15) is arranged so that it can be swiveled about an axis (30) extending parallel to the wide slot.

51. A device in accordance with claim 38, characterized in that the transport installation is provided with regulatable driving means, so that the substrate can be transported at a predetermined and settable speed, preferably between 2.0 and 30.0 m/min.

52. A device in accordance with claim 38, characterized in that a hardening furnace (39) or final treatment plant for the coated plate-shaped substrates is arranged adjacent to the chamber (37) in the transport direction.

53. Use of a device (11) in accordance with claim 38 with a wide slot pourer for the continuous coating of large areas of transparent, plate-like substrates (21), in particular such substrates as plate glass for thin layers, with a coating solution containing as solid material components dissolved in a solvent at least one metal-alkoxy compound and at least one polymer, for optical and other surface improvements of transparent surfaces, in particular for the production of an antireflection coating.
